(19) United States
(12) Patent Application Publication
(10) Pub. No.: US 2002/0008922 A1
(43) Pub. Date: Jan. 24, 2002

(54) Actuator and micromirror for fast beam steering and method of fabricating the same

(76) Inventors: Robert A. Conant, Berkeley, CA (US); Jocelyn T. Nee, Albany, CA (US); Kam-Yin Lau, Danville, CA (US)

Correspondence Address: Pennie & Edmonds, LLP, 3300 Hillview Avenue, Palo Alto, CA, 94304, US

(21) Appl. No.: 09/769,965

(22) Filed: Jan. 24, 2001

Related U.S. Application Data
(63) Continuation-in-part of application No. 09/584,835, filed on May 31, 2000.

(51) Int. Cl. G02B 7/182

(52) U.S. Cl. 359/871

(57) ABSTRACT

A micromirror for fast beam steering and method of fabricating the same. The micromirror of the present invention is lightweight and optically flat, and includes a tensile membrane that is stretched under high tension across a rigid single-crystal silicon support rib structure. A thin layer of gold may be deposited on the polysilicon membrane to improve reflectivity. The tensile stress in the membrane gives the micromirror a very high resonant frequency, thereby allowing the mirror to be scanned at high frequencies without exciting resonant nodes that may compromise the flatness of the optical surface and ruin its optical properties. The tensile stress also causes the optical surface to be stretched flat. The micromirror of the present invention may be actuated by a staggered torsional electrostatic combdrive.

### RELATED APPLICATION

The instant application is a continuation-in-part application of co-pending application Ser. No. 09/584,835, entitled “STAGGERED TORSIONAL ELECTROSTATIC COMBDRIVE AND METHOD OF FORMING THE SAME”, filed on May 31, 2000.

This invention was made with Government support under Grant (Contract) No. EEC-9615774, awarded by the National Science Foundation. The Government has certain rights to this invention.

### BRIEF DESCRIPTION OF THE INVENTION

This invention relates generally to Micro-Electro Mechanical Systems (MEMS). More particularly, this invention relates to high-speed scanning micromirrors.

### BACKGROUND OF THE INVENTION

Micro-Electro Mechanical Systems (MEMS), which are sometimes called micromechanical devices or micromachines, are three-dimensional objects having one or more dimensions ranging from microns to millimeters in size. The devices are generally fabricated utilizing semiconductor processing techniques, such as lithographic technologies.

There are on going efforts to develop MEMS with scanning mirrors, referred to as scanning micromirrors. It is a goal to use scanning micromirrors in the place of scanning macro-scale mirrors, which are used in a variety of applications. For example, macro-scale mirrors are used in: barcode readers, laser printers, confocal microscopes, and fiberoptic network components. There are significant limitations to the performance of macro-scale scanners; in particular, their scanning speed, power consumption, cost, and size often preclude their use in portable systems. Scanning micromirrors could overcome these problems. In addition, higher-frequency optical scanning could enable new applications that are not practical with conventional scanning mirrors, such as raster-scanning projection video displays, and would significantly improve the performance of scanning mirrors in existing applications, such as laser printers. MEMS optical scanners promise to enable these new applications, and dramatically reduce the cost of optical systems.

Unfortunately, previously demonstrated MEMS mirrors have not been able to simultaneously meet the requirements of high scan speed and high resolution. A plethora of micromirror designs have been presented, but not one has been able to satisfy the potential of MEMS: a high-speed, high-performance scanning mirror.

Surface-micromachined scanning mirrors actuated with electrostatic combdrives have been shown to operate at high scan speeds (up to 21 kHz), but static and dynamic mirror deformation limits the resolution to less than 20% of the diffraction-limited resolution. Magnetically actuated mirrors have been demonstrated with high speed and large amplitude, but have not demonstrated high resolution, and often require off-chip actuation.

Many optical-MEMS applications depend on surfaces that are flat to within λ/4 or better (about 140 nm for visible wavelengths). Scanning micromirrors that are fabricated using surface-micromachining processes have shown non-planar mirror deformations of 1-2 μm. These deformations are not a problem for many mechanical systems, but they can seriously degrade performance of an optical system. Suggested ways to avoid deformations include: (1) using bulk micromachining to produce a flat, but comparatively thick, single-crystal silicon mirror, and (2) using planarization methods, such as chemical-mechanical polishing to make flat, thin-film mirrors. These methods, however, are disadvantageous. The thick single-crystal silicon mirrors have relatively large mass and therefore require actuators capable of exerting forces large enough to drive heavy loads. The surface-micromachined mirrors are lightweight, but they are not stiff enough to remain planar when damped by inertial forces imposed by high-frequency scanning.

In view of the foregoing, it would be highly desirable to provide a light, stiff mirror capable of retaining optical flatness during high-speed scanning.

### SUMMARY OF THE INVENTION

The present invention provides a Staggered Torsional Electrostatic Combdrive (STEC)/Tensile Optical Surface (TOS) micromirror that fulfills the potential of micromachined mirrors over conventional scanning mirrors—high scan speed, small size, and low cost with diffraction-limited optical performance. The scan speed of the STEC/TOS micromirror is difficult to achieve with large-scale optical scanners, and exceeds the performance of previously demonstrated micromachined scanning mirrors.

The STEC/TOS micromirror of the present invention includes a stationary combteeth assembly and a moving combteeth assembly. The moving combteeth assembly includes a torsional hinge for attaching to an anchor, and a TOS micromirror that is a lightweight and optically flat. Particularly, in one embodiment, the micromirror includes a tensile membrane of polysilicon that is stretched under high tension across a rigid single-crystal silicon support rib structure. A thin layer of gold may be deposited on the polysilicon membrane to improve reflectivity. The tensile stress in the membrane gives the micromirror a very high resonant frequency, thereby allowing the mirror to be scanned at high frequencies without exciting resonant nodes that may compromise the flatness of the optical surface and ruin its optical properties. The tensile stress also causes the optical surface to be stretched flat, allowing the optical surface to retain optical flatness during high-speed scanning.

A method of fabricating the STEC/TOS micromirror includes a step of deep trench etching a stationary combteeth structure in a first wafer. A second wafer is bonded to the first wafer to form a sandwich including the first wafer, an oxide layer, and the second wafer. The second wafer is patterned and etched to form a moving combteeth assembly that includes a TOS micromirror and a torsional hinge. The oxide layer is subsequently removed to release the staggered torsional electrostatic combdrive and the TOS micromirror.

### BRIEF DESCRIPTION OF THE DRAWINGS

For a better understanding of the invention, reference should be made to the following detailed description taken in conjunction with the accompanying drawings, in which:

FIG. 1 is a perspective view of a simplified Staggered Torsional Electrostatic Combdrive (STEC) of the invention in a resting position.

FIG. 2 is a perspective view of the simplified STEC of the invention in an activated position.

FIG. 3 is a perspective view of a STEC of the invention in a resting position.

FIG. 4 illustrates processing steps used to construct a STEC of the invention.

FIGS. 5A-5F illustrate the construction of a STEC of the invention in accordance with the processing steps of FIG. 4.

FIG. 6 illustrates an embodiment of the invention with dual mounted moving combteeth and an additional stationary combteeth assembly.

FIG. 7 illustrates an embodiment of the invention with stacked stationary combteeth assemblies.

FIG. 8 illustrates an embodiment of the invention with dual mounted moving combteeth and stacked stationary combteeth assemblies.

FIG. 9 is a perspective view of a STEC with a Tensile Optical Surface (TOS) micromirror.

FIG. 10 is backside view of the TOS micromirror of FIG. 9.

FIG. 11 illustrates processing steps used to construct a TOS micromirror of the invention.

FIGS. 12A-12E illustrate the construction of a TOS micromirror of the invention in accordance with the processing steps of FIG. 11.

FIG. 13 illustrates a cross-sectional view of a TOS micromirror according to an embodiment of the invention.

Like reference numerals refer to corresponding parts throughout the drawings.

### DETAILED DESCRIPTION OF THE INVENTION

A. Staggered Torsional Electrostatic Combdrive (STEC)

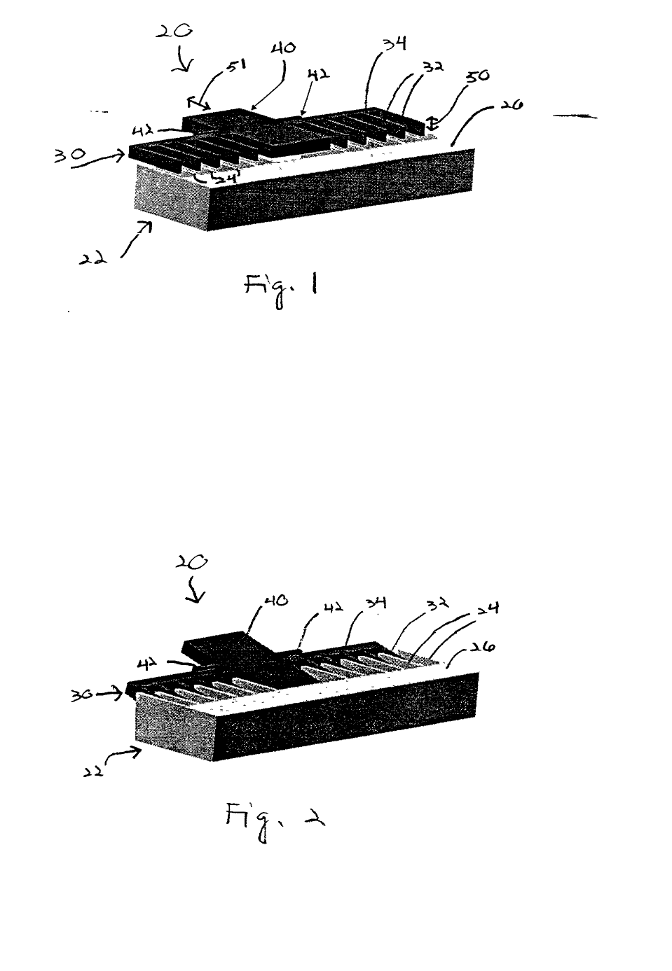

FIG. 1 illustrates a Staggered Torsional Electrostatic Combdrive (STEC) 20 in accordance with an embodiment of the invention. The STEC 20 includes a stationary combteeth assembly 22 including individual combteeth 24 formed on a combteeth spine 26. Positioned entirely above the stationary combteeth assembly 22 in a resting state is the moving combteeth assembly 30. The moving combteeth assembly 30 includes individual combteeth 32 linked by a combteeth spine 34. The moving combteeth assembly 30 also includes a mirror or paddle 40 with associated torsional hinges 42.

Those skilled in the art will appreciate that the positioning of the moving combteeth assembly 30 such that it is entirely over the stationary combteeth assembly 22 during fabrication and in a resting state departs from the prior art. In the prior art, stationary and moving combteeth overlap during fabrication and in a resting state. In contrast, with the STEC system 20, the moving combteeth assembly 30 in its as-fabricated position is 0.2 to 3.0 microns above the stationary combteeth assembly 22. This vertical displacement between the stationary and moving combteeth assemblies also exists in the resting state, as shown in FIG. 1. The vertical displacement between the stationary and moving combteeth assemblies of the invention allows for a larger mirror displacement range. Further, this vertical displacement allows for simplified fabrication techniques, as discussed below.

FIG. 2 illustrates the STEC system 20 in an activated state. This state is achieved by applying a voltage between the moving combteeth assembly 30 and the stationary combteeth assembly 22. The applied voltage attracts the moving combteeth assembly to the fixed combteeth assembly, thus exerting torque on the torsional hinges 42, forcing the mirror to tilt. The torsional hinges 42, which are anchored, provide restoring torque when the voltage is removed. Observe that the mirror 40 moves directly in response to the movement of the combteeth assembly 30. In other words, the movement of the combteeth assembly 30 is not directed to an intermediate structure, such as a spring, which applies the force to the mirror 40, as is the case in many prior art combdrive designs.

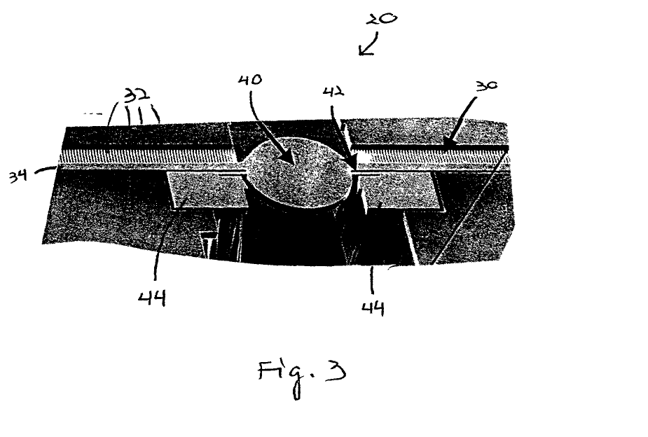

FIG. 3 provides a perspective detailed view of the STEC system 20. The figure clearly illustrates the moving combteeth assembly 30. In addition to having individual combteeth 32 and a combteeth spine 34, the moving combteeth assembly 30 has a mirror 40 and torsional hinges 42, which terminate in anchors 44. FIG. 3 illustrates the STEC system 20 in a resting state. In an active state, the moving combteeth assembly 30 turns into the page, causing the far side of the mirror 40 to turn into the page and the near side of the mirror 40 to lift out of the page.

The STEC system 20 may be implemented with a combteeth thickness, as shown with arrow 50 in FIG. 1, of between 10 and 500 microns, preferably between approximately 50 and 100 microns. Similarly, the thickness of the mirror 40 is between 10 and 500 microns, preferably between approximately 50 and 100 microns. Arrow 51 of FIG. 1 illustrates a lateral dimension. The lateral dimension of the mirror 40 is preferably less than 10 millimeters, more preferably between 550 microns and 2000 microns. The gap between individual combteeth is preferably less than 30 microns, preferably between approximately 2 and 10 microns.

The STEC system 20 offers several advantages over other electrostatic-actuator designs. First, the actuator applies torque to the mirror directly there are no hinges to couple linear motion of an actuator into torsional mirror motion. This greatly simplifies the design of the structure, and makes post-fabrication assembly steps unnecessary.

Second, the actuator starts in an unbalanced state and is capable of static mirror positioning as well as resonant scanning. Previously demonstrated balanced torsional electrostatic actuators have been very promising for resonant operation, but are not capable of static mirror positioning.

Third, the torsional combdrive offers an advantage over gap-closing actuators because the energy density in the combdrive is higher than that in a gap-closing actuator, thereby allowing larger scan angles at high resonant frequencies.

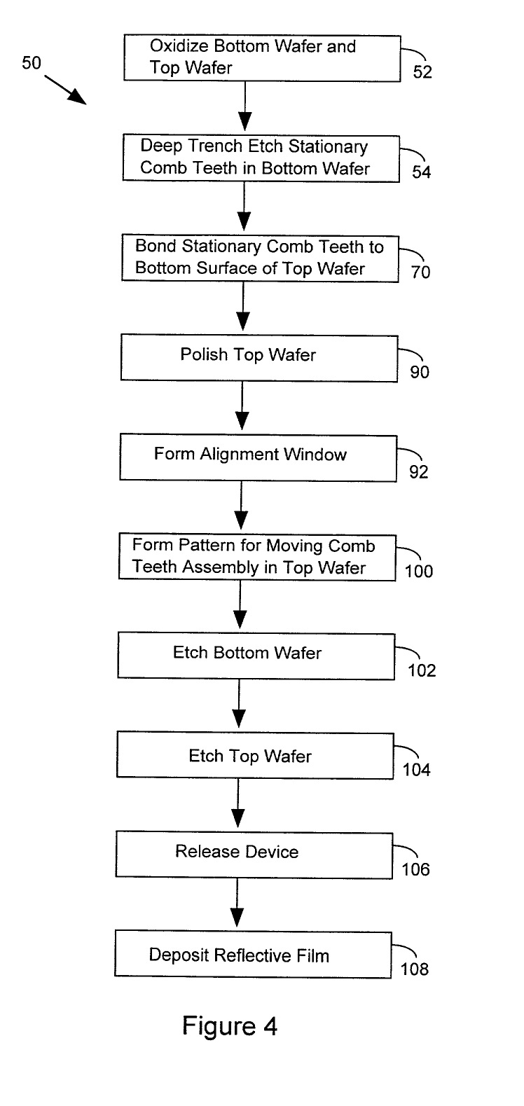

The structure and benefits of the STEC system 20 have been described. Attention now turns to fabrication techniques that may be used to construct the device. FIG. 4 illustrates processing steps 50 used in accordance with an embodiment of the invention. The first processing step shown in FIG. 4 is to oxidize a bottom wafer and a top wafer (step 52).

By way of example, the bottom silicon wafer may be oxidized in steam at 1000° C. to grow 0.2 μm of thermal oxide. The top silicon wafer maybe oxidized in steam at 1000° C. to grow 1.5 μm of thermal oxide. Advantageously, the top silicon wafer may be formed of single-crystal silicon.

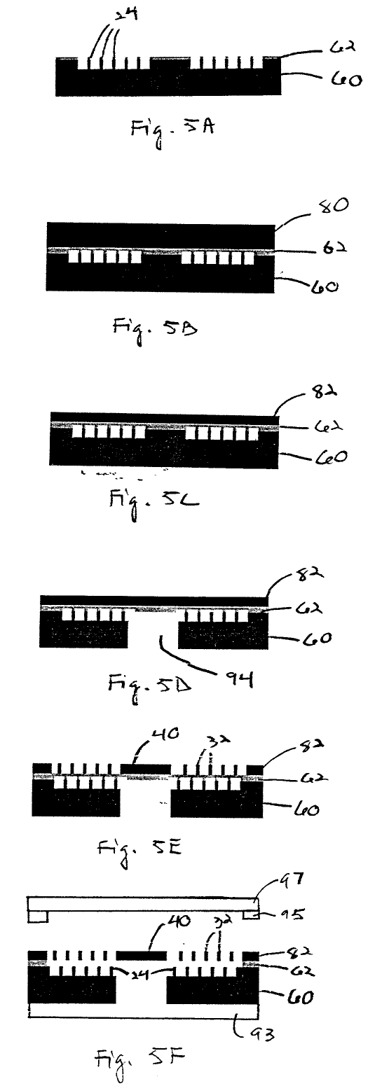

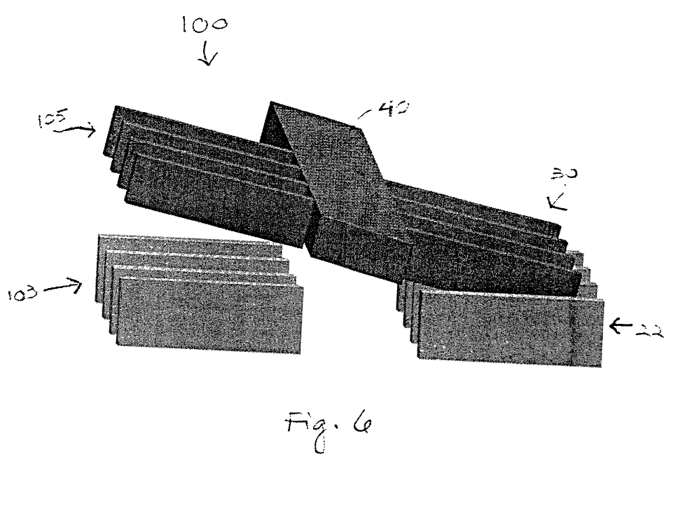

The next processing step in FIG. 4 is to deep trench etch stationary combteeth into the bottom wafer (step 54). In particular, the bottom wafer is patterned and 100 μm-deep trenches are etched into the wafer using an STS deep reactive-ion etcher to form the stationary combteeth assembly. FIG. 5A illustrates the results of this processing step. In particular, FIG. 5A illustrates a bottom wafer 60 with an oxide layer 62. Individual combteeth 24 of the stationary combteeth assembly 22 are shown in FIG. 5A.

The next processing step shown in FIG. 4 is to bond the stationary combteeth of the bottom wafer to the bottom surface of the top wafer (step 70). Preferably, this bonding process includes a step of cleaning each wafer prior to bonding and of annealing the bonded wafer pair at approximately 1100° C. for approximately one hour to increase the bond strength. The result of this processing is shown in FIG. 5B. In particular, FIG. 5B illustrates a top wafer 80 bonded to the bottom wafer 60 through an oxide layer 62.

The next processing step of FIG. 4 is to polish the top wafer (step 90). In particular, the top wafer is ground and polished to leave a 50 μm-thick layer of silicon above the oxide interface 62. FIG. 5C illustrates the result of this processing. The figure shows the polished top wafer 82 with a significantly smaller vertical height than the pre-polished top wafer 80 of FIG. 5B. The polishing step 90 preferably includes the step of oxidizing the bonded structure at 1 100° C. in a steam ambient to form, for example, a 1.1 μm-thick oxide layer on the top and bottom surfaces of the bonded structure.

The next processing associated with FIG. 4 is to form an alignment window (step 92). The alignment window is used to provide an alignment reference for the subsequent patterns and the buried combteeth. The alignment window is formed by etching a window in the top wafer, with the oxide layer 62 operating as a stop layer.

The next processing step is to form the moving combteeth assembly in the top wafer (step 100). In particular, the front side pattern, which defines the moving combteeth, the mirror, the torsion hinges, and the anchor is then patterned and etched into the top oxide layer. The pattern is subsequently etched into the silicon wafer 82 (as discussed below in connection with step 104). The alignment of this step is critical because misalignment between the moving combteeth and the fixed combteeth can lead to instability in the torsional combdrive. By using a wafer stepper, alignment accuracy of better than 0.2 μm between the buried pattern and the frontside pattern may be achieved.

The next processing step in FIG. 4 is to etch the backside hole in the bottom wafer (step 102). In particular, the silicon 60 on the backside of the bottom wafer is patterned with the hole layer, and the backside hole 94 is etched in the bottom wafer to open an optical path underneath the micromirror. FIG. 5D illustrates a backside hole 94 formed in the bottom wafer 60.

The next processing step in FIG. 4 is to etch the top wafer (step 104). In particular, this step entails etching the top wafer 82 using the previously patterned top oxide layer as an etch mask. This processing results in the structure of FIG. 5E. FIG. 5E illustrates individual combteeth 32 of the moving combteeth assembly 30. The figure also illustrates the mirror 40.

The next processing step shown in FIG. 4 is to release the device (step 106). The structure may be released in a timed HF etch to remove the sacrificial oxide film below the combteeth and mirror. This results in the structure of FIG. 5F.

FIG. 4 illustrates a final optional step of depositing a reflective film (step 108). That is, a 100 nm-thick aluminum film may be evaporated through gap 94 onto the bottom of the mirror to increase the reflectivity for visible light. The structure of the STEC micromirror of the invention allows access to the backside of the mirror surface, thereby allowing for this processing step. Instead of a reflective film, a multi-layered optical filter may be deposited.

As shown in FIG. 5F, a bottom transparent plate 93 may be attached to the bottom wafer 60 and a top transparent plate 97 with a spacer 95 may be attached to the silicon wafer 82. The transparent plates may be glass or quartz. Thus, during operation, light passes through a transparent plate, hits the mirror, and reflects back through the transparent plate.

The fabrication of the device has now been described. Attention now turns to the performance achieved by a device formed in accordance with an embodiment of the invention. The performance of the device will be discussed in the context of optical resolution. The optical resolution—defined as the ratio of the optical-beam divergence and the mirror scan angle—is an essential performance metric for a scanning mirror. For a perfectly flat mirror under uniform illumination, the farfield intensity distribution is an Airy pattern, which has a full-width-half-max half-angle beam divergence a (the resolution criteria used for video displays) given by

$$α = \frac{1.03 λ}{D} \qquad [ 1 ]$$

where λ is the wavelength of the incident light and D is the mirror diameter. The resulting optical resolution N is

$$N = \frac{4 θ D}{α} = \frac{4 θ D}{1.03 λ} \qquad [ 2 ]$$

where θ is the mechanical half-angle mirror scan (the total optical scan is 4θ).

Dynamic mirror deformation can also contribute to beam divergence, thereby decreasing the optical resolution. For a mirror where the torsion hinge is the dominant compliance, the nonplanar surface deformation δ of a rectangular scanning mirror of half-length L with angular acceleration (2πƒ) (where ƒ is the scan frequency) is

$$δ = 0.183 \frac{ρ ( 1 - {v}^{2} ) {( 2 π f )}^{2} θ}{{Et}^{2}} {L}^{5} \qquad [ 3 ]$$

where ρ is the material density, v is Poisson's ratio, E is Young's modulus, and t is the mirror thickness.

The Rayleigh limit, the maximum amount of surface deformation tolerable without significant degradation in image quality, allows a peak-to-valley surface deformation of λ/4. For a 550 μm-long (275 μm-half-length) rectangular single-crystal-silicon mirror of thickness 50 μm, half-angle mechanical scan 6.25°, and resonant frequency 34 kHz, the calculated dynamic deformation is 8 nm—much lower than the Rayleigh limit for 655 nm light (164 mn). For comparison, a 550 μm-long surface-micromachined mirror of thickness 1.5 μm maintains the surface flatness within the Rayleigh limit only up to a frequency of 4.6 kHz.

The STEC mirror excels in all critical performance criteria: cost, resolution, scan speed, scan repeatability, size, power consumption, and reliability. The following text discusses measurements of four of these performance criteria for one STEC mirror design.

The surface deformation of the micromirror was characterized using a stroboscopic interferometer. The total deformation measured was less than 30 nm, considerably below the Rayleigh limit, and does not significantly reduce the optical resolution. Characterization tests also demonstrate that the spot size and separation at eight different regions across the scan give a measured total optical resolution of 350 pixels. The resolution of a 550 μm-diameter mirror with 24.9° optical scan and 655 nm laser light was near the diffraction-limited resolution of 355 pixels from Eq. [2].

The scan speed of the device of the invention is better than the scan speeds achieved in the prior art. STEC micromirrors have been demonstrated with diameters of 550 μm and resonant frequencies up to 42 kHz—almost an order of magnitude faster than commercially available optical scanners. Larger STEC mirrors have also been fabricated (up to 2 mm) with lower resonant frequencies.

The main limitation of macro-scale scanners comes from the dynamic deformation described by Eq. [3]—the dynamic deformation scales as the fifth power of the mirror length, so large mirrors scanning at high speeds will have considerable dynamic deformation. For example, a 10 mm-diameter, 1 mm-thick mirror with a mechanical scan of ±6.25° maintains less than 164 nm dynamic deformation (the Rayleigh limit for 655 nm light) up to a frequency of only 2.2 kHz. Large-scale mirrors cannot achieve the speeds demonstrated with the STEC micromirrors without severe dynamic deformation or very thick mirrors.

High-speed scanners require more torque than low-speed scanners to reach the same scan angle. In order to generate the torque necessary for large angle, high-frequency operation of the STEC micromirror, relatively high voltages are used. The 550 μm-diameter mirror with a resonant frequency of 34 kHz requires a 171 Vrms input sine wave for a total optical scan of 24.9°. To simplify mirror testing and operation, a small (1 cm³) 25:1 transformer is used, allowing the use of a conventional 0-10 V function generator to drive the scanning mirrors with a sinusoidal waveform of amplitude up to 250 V. The use of the transformer also provides efficient power conversion, so the power consumption of the entire system can be much lower than systems requiring high-voltage power supplies and opamps.

This power consumption is the sum of the power dissipation in the drive electronics and the power dissipated by air and material damping. The power consumption due to damping is

$$P = \frac{1}{2} {{bθ}^{}}^{2} {ω}^{2} = \frac{1}{2} \frac{k}{Q} {θ}^{2} ω \qquad [ 4 ]$$

where k is the torsional spring stiffness, b is the torque damping factor, θ is the mechanical scan half angle (the total optical scan is ±2θ₀), ω is the resonant frequency, and Q is the resonant quality factor. For the 34 kHz 550 μm-diameter mirror scanning 25° optical (±6.25° mechanical), the calculated stiffness k=3.93×10⁻⁵ Nm/radian, the measured resonant quality factor Q=273, so the power consumption due to damping from Eq. [4] is 0.18 mW. Vacuum packaging can be used to reduce the viscous damping, and thereby decrease the power consumption.

The measured power consumption is 6.8 mW, indicating that the majority of the power consumption is in charging and discharging the parasitic capacitance and losses in the transformer power conversion.

The STEC micromirror is extremely reliable due to its simple structure. It is predicted that the failure point for the structure will be the torsion hinges (at the point of highest strain). The maximum strain in a 50 μm-thick, 15 μm-wide, 150 μm-long hinge (the hinge used for the 550 μm-diameter mirror with resonant frequency of 34 kHz) with a total scan of ±6.25° is approximately 1.8%. Mirrors have been operated at this level for over 200 million cycles without any noticeable degradation in performance. Wider and longer hinges may be used to reduce strain while retaining the same stiffness.

Attention now turns to variations of the STEC micromirror technology. Individual STEC micromirrors of the invention can be combined to form two-dimensional scanners. Advantageously, the capacitance of the combteeth may be used as an integrated mirror-position feedback sensor. An independent comb can be added to the frontside mask to allow capacitive measurement of the mirror position independent of the drive voltage. An independent comb can be added to the frontside mask to allow frequency tuning of the micromirror resonance. A separate combdrive can be added to the mirror to allow bidirectional scanning. These embodiments are shown in connection with FIGS. 6-8.

FIG. 6 illustrates an embodiment of the invention with a dual-mounted moving combteeth assembly 100. The figure illustrates the previously discussed components of a stationary combteeth assembly 22, a moving combteeth assembly 30, and a mirror or paddle 40. In accordance with this embodiment of the invention, the moving combteeth assembly 30 includes an additional set of combteeth 105. The additional set of combteeth 105 may be attached to the mirror 40, as shown in FIG. 6. Alternately, the combteeth 105 may be positioned on the same spine supporting the moving combteeth assembly 30. In other words, in this alternate embodiment, a single spine 34 of the type shown in FIGS. 1-3 has combteeth extending from both sides of the spine. FIG. 6 further illustrates an additional stationary combteeth assembly 103. Applying a voltage between the additional set of combteeth 105 and the additional stationary combteeth assembly 103 causes the mirror 40 to tilt towards the additional stationary combteeth assembly 103.

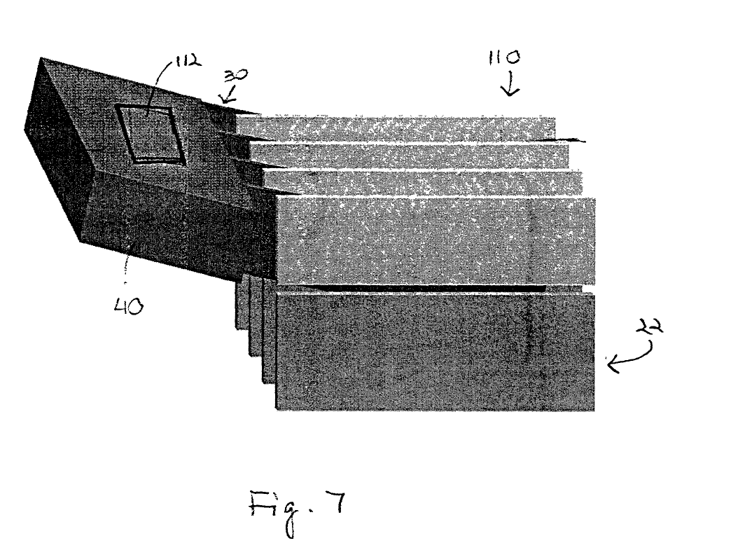

FIG. 7 illustrates an alternate embodiment of the invention which includes a stacked combteeth assembly 110. The figure illustrates the previously discussed components of a stationary combteeth assembly 22, a moving combteeth assembly 30, and a mirror or paddle 40. Positioned over the stationary combteeth assembly 22 is a stacked combteeth assembly 110. Preferably, the stacked combteeth assembly 110 is electrically isolated from the moving combteeth assembly 30 and the stationary combteeth assembly 22. This configuration allows for simplified capacitive sensing by the stacked combteeth assembly 110. The stacked combteeth assembly 110 may also be independently controlled for resonant frequency tuning.

FIG. 7 also illustrates a mounted electronic component 112 positioned on the paddle 40. By way of example, the mounted electronic component 112 may be an ultrasonic transducer or an ultrasonic sensor.

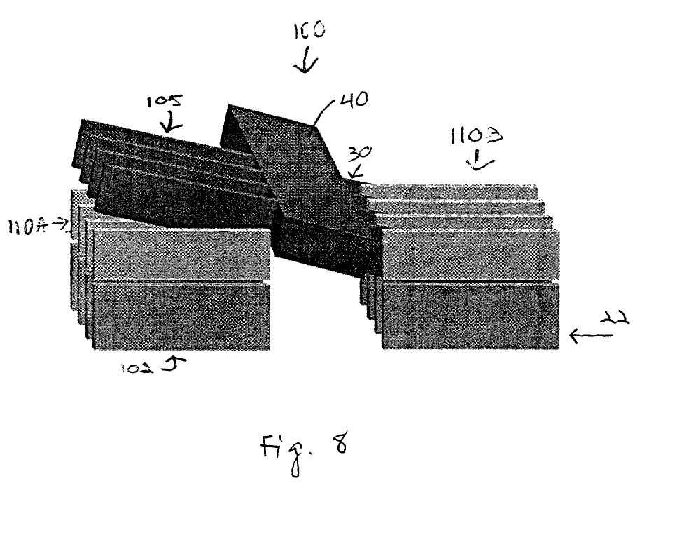

FIG. 8 illustrates another embodiment of the invention in which the features of FIGS. 6 and 7 are combined into a single device. In particular, the figure shows the dual-mounted moving combteeth assembly 100 operative in connection with a set of stacked combteeth assemblies 110A and 110B.

B. Tensile Optical Surface (TOS) Micromirror

High-speed beam-steering applications require micromirrors that are optically flat, lightweight, and having large deflection angles. Micromirrors that are made from thick slabs of single-crystal silicon are optically flat. Those micromirrors, however, are relatively heavy and require stiff torsion hinges for high-frequency scanning. The high torsion-hinge stiffness makes large deflection angles difficult to achieve in those micromirrors, particularly under DC (Direct Current) conditions.

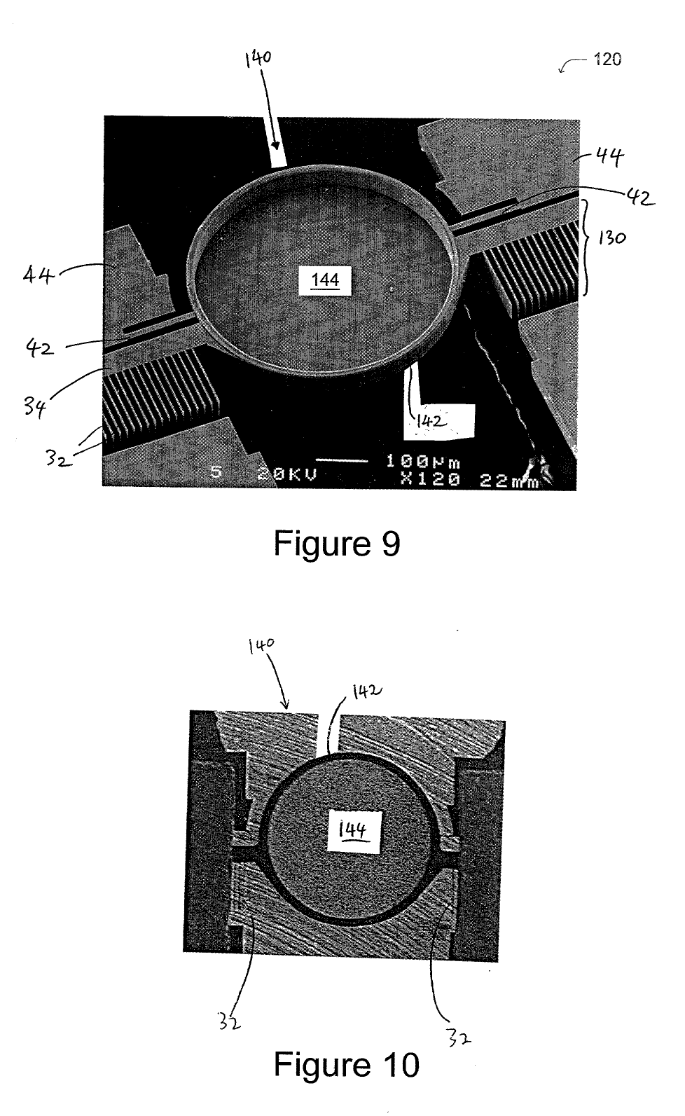

The Staggered Torsional Electrostatic Combdrive/Tensile Optical Surface (STEC/TOS) micromirror of the present invention is significantly more advantageous over micromirrors made from thick slabs of single-crystal silicon. FIG. 9 is a perspective detailed view of a STEC/TOS micromirror device 120 in accordance with an embodiment of the present invention. As illustrated in FIG. 9, the STEC/TOS micromirror device 120 is in a resting state. In an activated state, the moving combteeth assembly 130 turns into the page, causing the far side of the mirror 140 to lift out of the page and the near side of the mirror 140 to turn into the page. FIG. 10 is a bottom view of the STEC/TOS micromirror device 120 in a resting state. With respect to FIG. 10, when the STEC/TOS micromirror device 120 is in the activated state, the moving combteeth assembly 130 turns out of the page, causing the far side of the mirror 140 to turn into the page and the near side of the mirror 140 to lift out of the page.

With reference again to FIG. 9, the moving combteeth assembly 130 of the STEC/TOS micromirror device 120 includes individual combteeth 32, a combteeth spine 34, torsional hinges 42 that terminate in anchors 44, and a TOS micromirror 140. Significantly, TOS micromirror 140 is not a slab of rigid single-crystal silicon. Rather, the TOS micromirror 140 is composed of a tensile membrane 144 supported by a rigid support rib structure 142. The TOS micromirror 140 is like a “drum”—the optical surface is tensile and stretches across the support rib structure 142. In one embodiment of the invention, the support rib structure 142 is formed with single-crystal silicon, and membrane 144 is formed with a thin layer of polysilicon. In other embodiments, the membrane 144 may be formed with one or multiple layers of materials, including but not limited to polysilicon films, plastic films, silicon nitride films, and/or metallic films. The tensile stress of the optical surface may be between approximately 50 MPa (mega-pascals) and 1 GPa. Preferably, the tensile stress of the optical surface is between approximately 100 MPa and 300 MPa.

It should be noted that in the embodiment illustrated in FIGS. 9 and 10, the rigid support rib structure 142 has a circular shape. In other embodiments of the present invention, the rigid support rib structure 142 may assume other geometrical shapes. In addition, the rigid support rib structure 142 may include spokes, crosses, honeycombs, other structures on which the membrane 144 may be mounted.

FIG. 13 is a cross-sectional view of the TOS micromirror 140 along its diameter. The height (H) of the rigid support rib structure can be between 1 μm and 1000 μm, preferably between 20 μm and 200 μm. The diameter (D) of the optical surface can be between 300 μm and 5000 μm, preferably between 500 μm and 2000 μm. The width (W) of the rigid support rib structure 142 can be between 5 μm to half the diameter (D) of the membrane 144, preferably between 1/40 and 1/10 of the diameter (D). The membrane 144 can have a thickness of between 0.05 μm and 5 μm, preferably between 0.5 μm and 1 μm.

According to one specific embodiment of the present invention, the height (H) of the rigid support rib structure 142 is approximately 30 μm; the width (W) of the rigid support rib structure 142 is approximately 15 μm; the thickness (t) of the membrane 144 is approximately 0.5 μm; and, the optical surface diameter (D) of the present embodiment is approximately 550 μm. The membrane 144, having a diameter of approximately 550 μm, has a resonant frequency in the hundreds of kHz, allowing the TOS micrormirror 140 to be scanned at tens of kHz without significantly exciting membrane resonant modes that may compromise its planarity.

The TOS micromirror 140 offers several advantages over micromirrors made from thick slabs of single-crystal silicon. First, the TOS micromirror 140 has a significantly lower mass moment of inertia. Therefore, the stiffness of torsion hinge 42 is reduced. Second, if the torsion hinge 42 is looser, the TOS micromirror 140 can achieve higher deflection angles at lower voltages. Third, because the TOS micromirror 140 has a large deflection angle, and because the combdrive assemblies can generate high actuation force at low voltages, the STEC/TOS system 120 can achieve high-speed, large-angle, and low-voltage beam steering heretofore unattainable in other micromirror-actuator designs. Fourth, the tensile stress in the membrane gives the TOS micromirror 140 a very high resonant frequency, thereby allowing it to be scanned at high frequencies without exciting resonant nodes that may compromise the flatness of the optical surface and ruin its optical properties.

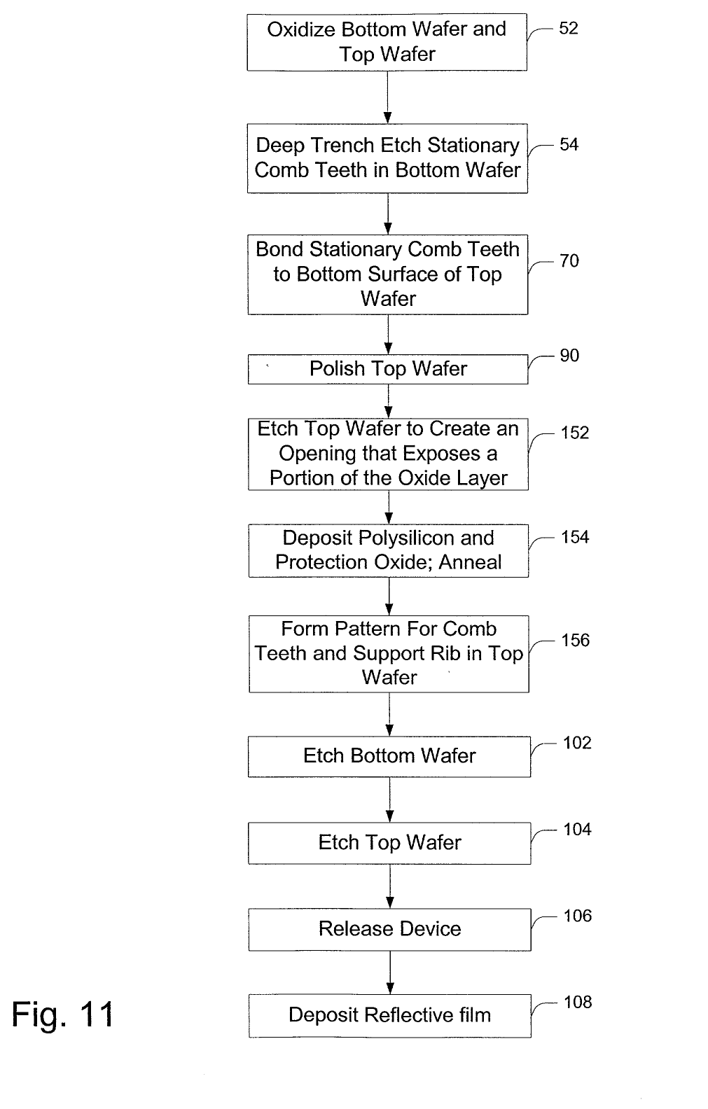

Attention now turns to fabrication techniques that may be used to construct the STEC/TOS micromirror device 120. FIG. 11 illustrates steps of a process 150 for fabricating the STEC/TOS micromirror device. The first processing step shown in FIG. 11 is to oxidize a bottom wafer and a top wafer (step 52).

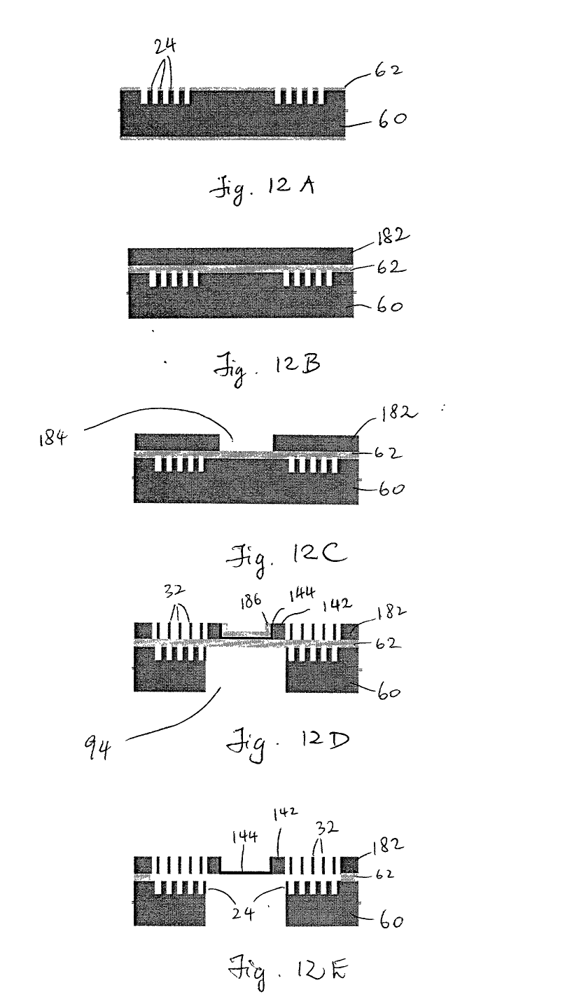

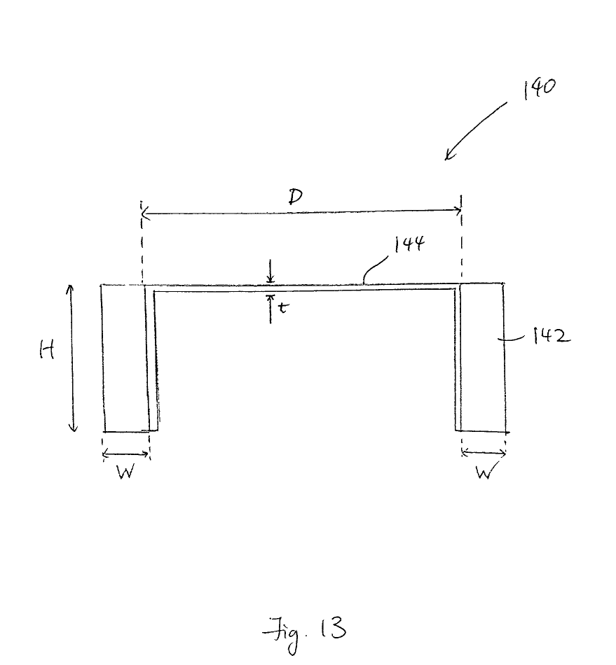

The next processing step in FIG. 11 is to deep trench etch stationary combteeth into the bottom wafer (step 54). In particular, the bottom wafer is patterned and 100 μm-deep trenches are etched into the wafer using an STS deep reactive-ion etcher to form the stationary combteeth assembly. FIG. 12A illustrates the results of this processing step. In particular, FIG. 12A illustrates a bottom wafer 60 with an oxide layer 62. Individual combteeth 24 of the stationary combteeth assembly 22 are shown in FIG. 12A.

The next processing step shown in FIG. 11 is to bond the stationary combteeth of the bottom wafer to the bottom surface of the top wafer (step 70). Preferably, this bonding process includes a step of cleaning each wafer prior to bonding and a step of annealing the bonded wafer pair at approximately 1100° C. for approximately one hour to increase the bond strength.

The next processing step of FIG. 11 is to polish the top wafer (step 90). In particular, the top wafer is ground and polished to leave a 50 μm-thick layer of silicon above the oxide interface 62. The result of this processing step is shown in FIG. 12B. In particular, FIG. 12B illustrates a top wafer 182, which has a polished top, bonded to the bottom wafer 60 through an oxide layer 62.

The next processing step associated with FIG. 11 is to pattern and etch the top wafer to create an opening that exposes a portion of the sandwiched oxide layer (step 152). FIG. 12C illustrates the result of this processing step. As shown, the top wafer 182 is etched to create an opening 184 that exposes a portion of the oxide layer 62.

The next processing step is to deposit a layer of polysilicon and subsequently a layer of protective oxide over the exposed portion of the oxide layer (step 154). Preferably, the polysilicon layer and the protective oxide layer are deposited using Low Pressure Chemical Vapor Deposition (LPCVD) techniques. Further, this processing step also includes a step of annealing the polysilicon layer and the protective oxide layer such that a desired level of tensile stress is created in the polysilicon layer. Annealing techniques for achieving a desired level of tensile stress in polysilicon films are well known in the art. For instance, a discussion of such annealing techniques can be found in H. Guckel, D. W. Bums, C. C. G. Visser, H. A. C. Tilmans, D. Deroo, “Fine-grained polysilicon films with built-in tensile strain,” IEEE Transaction on Electronic Devices, vol. 35, no. 6, pp. 800-1.

The next processing step is to form a front side pattern that defines the moving combteeth, the support rib structure, the torsion hinges, and the anchor in the top oxide layer. The pattern is subsequently etched into the top wafer (as discussed below in connection with step 104).

The next processing step in FIG. 11 is to etch a backside hole in the bottom wafer (step 102). In particular, the silicon 60 on the backside of the bottom wafer is patterned with the hole layer, and the backside hole 94 is etched in the bottom wafer to open an optical path underneath the micromirror.

The next processing step in FIG. 11 is to etch the top wafer (step 104). In particular, this step entails etching the top wafer 182 using the previously patterned top oxide layer as an etch mask. This processing results in the structure of FIG. 12D. FIG. 12D illustrates the individual combteeth 32 of the moving combteeth assembly and the support rib 142. FIG. 12D also illustrates a backside hole 94 formed in the bottom wafer 60 at step 102, and polysilicon membrane 144 and protection oxide layer 186 that are deposited at step 154.

The next processing step shown in FIG. 11 is to release the device (step 106). The structure may be released in a timed HF etch to remove the sacrificial oxide film below the combteeth and mirror. This results in the structure of FIG. 12E.

FIG. 11 illustrates a final step of depositing a reflective film on the membrane surface (step 108). A 50 nm-thick gold film may be evaporated through gap 94 onto the bottom of the mirror to increase the reflectivity for visible light. The effect of adding a 50 nm thick layer of gold to improve reflectivity is found to be negligible on the deformation of the micromirror. A thin film of aluminum may also be used.

The present invention, a staggered torsional electrostatic combdrive with tensile optical surface micromirror, has thus been disclosed. Many variations of the disclosed STEC/TOS micromirror device are possible. For instance, individual STEC/TOS micromirrors of the invention can be combined to form two-dimensional scanners. As another example, the TOS micromirror may be used in conjunction with a dual-mounted combdrive assembly, a stacked combdrive assembly, or a dual-mounted stacked combdrive assembly.

The foregoing descriptions of specific embodiments of the present invention are presented for purposes of illustration and description. They are not intended to be exhaustive or to limit the invention to the precise forms disclosed, obviously many modifications and variations are possible in view of the above teachings. The embodiments were chosen and described in order to best explain the principles of the invention and its practical applications, to thereby enable others skilled in the art to best utilize the invention and various embodiments with various modifications as are suited to the particular use contemplated. It is intended that the scope of the invention be defined by the following claims and their equivalents.

What is claimed is:

1. A micromirror, comprising:
a rigid support rib; and
a membrane stretched across and fixedly mounted on the rigid support rib to form an optical surface of the micromirror.

2. The micromirror of claim 1, wherein the rigid support rib comprises a substantially circular member and wherein the optical surface of the micromirror comprises a substantially circular shape.

3. The micromirror of claim 2, wherein the optical surface has a diameter between 500 μm and 2000 μm.

4. The micromirror of claim 1, wherein the rigid support rib comprises single-crystal silicon.

5. The micromirror of claim 1, wherein the membrane comprises a layer of annealed polysilicon.

6. The micromirror of claim 5, wherein the layer of annealed polysilicon has a thickness of between approximately 0.5 μm and 1 μm.

7. The micromirror of claim 5, wherein the membrane further comprises a reflective film covering the optical surface.

8. The micromirror of claim 7, wherein the reflective film comprises a tensile metallic film.

9. The micromirror of claim 8, wherein the tensile metallic film comprises gold.

10. The micromirror of claim 7, wherein the tensile metallic film comprises aluminum.

11. The micromirror of claim 10, wherein the tensile metallic film comprises silver.

12. The micromirror of claim 1, wherein the membrane comprises a layer of annealed silicon nitride.

13. The micromirror of claim 1, wherein the membrane comprises a layer of tensile metallic film.

14. The micromirror of claim 1, wherein the membrane comprises a layer of tensile plastic film.

15. The micromirror of claim 1, wherein the rigid support rib has a height of between approximately 20 μm and 200 μm.

16. The micromirror of claim 2, wherein the rigid support rib has a width of between approximately 1/40 and 1/10 of a diameter of the substantially circular member.

17. The mircormirror of claim 1, wherein the optical surface has a tensile stain between approximately 50 MPa and 1 GPa.

18. A method of fabricating a micromirror, comprising:
bonding a first wafer to a second wafer to form a sandwich including the first wafer, an oxide layer, and the second wafer;
etching the second wafer to expose an first portion of the oxide layer;
depositing a polysilicon layer on the first exposed portion of the oxide layer;
depositing a protective oxide layer on the polysilicon layer;
annealing the polysilicon layer to yield a pre-determined tensile stress therein;
etching the second wafer to form a support rib structure after depositing the protective oxide layer;
etching a backside of the first wafer to expose a second portion of the oxide layer; and
removing the exposed second portion of the oxide layer to release the micromirror.

19. The method of claim 18, further comprising sputtering a reflective material on the polysilicon layer.

20. The method of claim 19, wherein the sputtering comprises sputtering a film of gold on the polysilicon layer.

21. The method of claim 19, wherein the sputtering comprises sputtering a film of silver on the polysilicon layer.

22. The method of claim 19, wherein the sputtering comprises sputtering a film of aluminum on the polysilicon layer.

23. A method of fabricating a micromirror, comprising:
bonding a first wafer to a second wafer to form a sandwich including the first wafer, an oxide layer, and the second wafer;
etching the second wafer to expose an first portion of the oxide layer;
depositing a silicon nitride layer on the first exposed portion of the oxide layer;
depositing a protective oxide layer on the silicon nitride layer;
annealing the silicon nitride layer to yield a pre-determined tensile stress therein;
etching the second wafer to form a support rib structure after depositing the protective oxide layer;
etching a backside of the first wafer to expose a second portion of the oxide layer; and
removing the exposed second portion of the oxide layer to release the micromirror.

24. The method of claim 23, further comprising sputtering a reflective material on the silicon nitride layer.

25. The method of claim 24, wherein the sputtering comprises sputtering a film of gold on the silicon nitride layer.

26. The method of claim 24, wherein the sputtering comprises sputtering a film of silver on the silicon nitride layer.

27. The method of claim 24, wherein the sputtering comprises sputtering a film of aluminum on the silicon nitride layer.
